(19) United States
(12) Patent Application Publication
(10) Pub. No.: US 2017/0212273 A1
(43) Pub. Date: Jul. 27, 2017

(54) A BOREHOLE SENSING SEISMIC FIBER OPTIC TOOL

(71) Applicant: SCHLUMBERGER TECHNOLOGY CORPORATION, Sugar Land, TX (US)

(72) Inventors: Evgeny Pavlovich Andrienko, Gagarin (RU); Dimitri Vladilenovich Pissarenko, Chatenay-Malabry (FR); Yamid Pico, Moscow (RU)

(21) Appl. No.: 15/326,798

(22) PCT Filed: Jul. 17, 2014
(86) PCT No.: PCT/RU2014/000519

§ 371 Date: Jan. 17, 2017

(51) Int. Cl. G01V 8/24; G01H 9/00

(52) U.S. Cl. CPC G01V 8/24; G01H 9/004

(57) ABSTRACT

A borehole seismic sensing fiber optic tool comprises a fiber optic cable to be lowered in a borehole and at least one resonator array disposed on the fiber optic cable. Each array comprises at least one active element having resonance self-frequency in a range of frequencies of seismic waves to be measured.

### FIELD OF THE INVENTION

The invention relates to borehole seismic surveying and more particularly to detection of seismic and micro seismic events using fiber optic distributed sensors.

### BACKGROUND OF THE INVENTION

In oil and gas industry, acoustic tools are used to provide operationally significant information about seismic events occurring during explorations phase of the new fields and production phases of existing ones. The borehole seismic data can be utilized to determine subsurface geological structure and refine surface seismic data. Borehole seismic data can further be gathered on a continuing or recurrent basis to monitor subsurface formation and reservoirs during production of the well. The gathering of seismic data on a continuing basis facilitates extraction of gas or oil deposits.

In general, borehole seismic surveys are performed by recording seismic signals using a single sensor or an array of sensors located in a borehole. Seismic signals may be generated by one or more seismic sources located on the earth surface, in the borehole in which the seismic signals are detected, in an adjacent borehole, and/or in the formation surrounding the borehole. The seismic energy generated as a result of the seismic source may be recorded by various types of seismic sensors, such as hydrophones, geophones, accelerometers, or a combination thereof. Usually such sensors are coupled to electrical components downhole which amplify and digitize the electrical signals generated by the sensors [symbol] ponse to detection of a seismic event. The digitized signals may then be transmitted (e.g., via electrical wireline, mud pulse telemetry, fiber optic cable, etc.). The need for downhole electronics adds to the physical size, cost and complexity of the survey tool, particularly since the electronics must be able to withstand, or be protected from, elevated temperatures and pressures of the downhole environment for extended periods of time.

For example, a typical borehole seismic tool is described in U.S. patent application Ser. No. 10/104,320 and entitled “Method and Apparatus for Borehole Sensing”.

Seismic and micro seismic signals propagating through an earth formation can be detected using fiber optic distributed vibration sensors located in the borehole. The small diameter of the optical fibers allows for deployment of the fiber optic distributed sensor either inside or behind production tubing or the drill string. Besides, an optical fiber seismic signal detection system does not require costly downhole electronics. Instead, the electronics for acquiring seismic data from the fiber optic sensor all may be located on the surface. Fiber optic sensing systems used for measuring seismic signals are described, for example, in U.S. Pat. No. 8,605,542 or U.S. patent application 20140064028. One of disadvantages of such systems between others is the limitation for acquiring vector signals due to the fact that sensing capabilities of the signal are omnidirectional.

The suggested borehole seismic tool provides for enhanced measurement characteristics of the acquisition system in comparison with existing ones. The [symbol] [symbol] to reduce tube wave noise by velocity filtering can make this a preferred alternative to clamped geophones.

### SUMMARY OF THE INVENTION

One embodiment of the invention provides a borehole seismic sensing fiber optic tool comprising a fiber optic cable to be lowered in a borehole and at least one resonator array disposed on the fiber optic cable, each resonator array consisting of at least one active element having a resonance self-frequency in a range of frequencies of seismic waves to be measured.

The active elements of each resonator array can be discs, spheres or cylinders.

The active elements of each resonator array can be made of piezoceramics.

In some embodiments resonator arrays are disposed in shuttles, each shuttle comprising at least one resonator array.

### BRIEF DESCRIPTION OF THE DRAWINGS

Certain embodiments of the invention will hereafter be described with reference to the accompanying drawings, wherein like reference numerals denote like elements. It should be understood, however, that the accompanying drawings illustrate only the various implementations described herein and are not meant to

[symbol]

FIG. 1c shows a resonator array having spheres as active elements in accordance with an embodiment of the invention.

FIG. 2 shows a block diagram of an exemplary interrogation and data acquisition system to acquire information from a sensing seismic fiber optic tool deployed in a borehole in accordance with an embodiment of the invention.

### DETAILED DESCRIPTION

The present invention provides a borehole sensing fiber optic tool for measuring seismic and micro seismic events in a borehole.

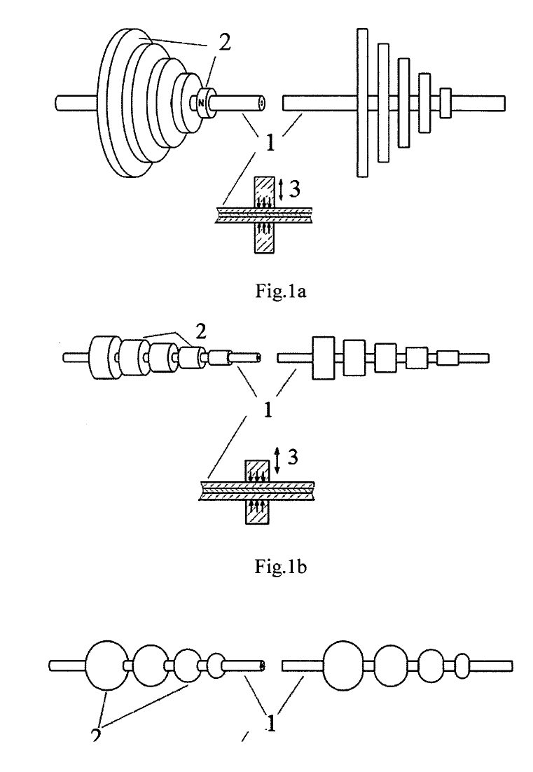

As shown on FIG. 1a, 1b and 1c the tool comprises a fiber optic cable 1 to be lowered in a borehole and one sensor array disposed on the fiber optic cable 1, the sensor array comprises at least one active element (resonator) 2. Material, shape and design of the active elements 2 could be different. The active elements can be made, for example as discs, cylinders or spheres, as it is illustrated on the FIG. 1 a, b and c. The array on FIG. 1a and FIG. 1b comprises five active elements, the array on FIG. 1c—four active elements. The size of the active elements and their number can vary depending on the frequencies of interest to be measured and the materials used. These active elements have special designed self-frequencies in a range of required frequency of seismic and micro seismic waves to be measured. The active elements can be made of piezoceramic, quartz, etc.

The seismic waves travel from a seismic source and when approaching the [symbol] [symbol] des high sensitivity to strain change in a specific position of the fiber optic cable under the sensor for a specific frequency. An array of such active elements 2 can cover any band of frequency of interest. Also each active element 2 acts as a local filter and multiplayer of the signal.

The resonator arrays can be disposed in shuttles (not shown), each shuttle comprising at least one resonator array, to get needed configuration that is optimal for each seismic survey such as VSP, microseismics, etc.

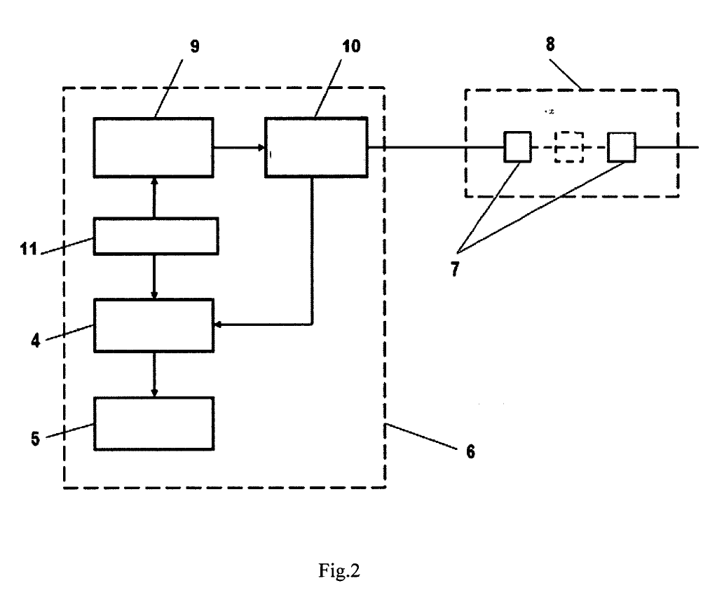

Any fiber optic interrogation system can be used. FIG. 2 illustrates an exemplary embodiment of a data acquisition and interrogation system 6 that may be used with a sensing seismic fiber optic tool 8 for measurements. System 6 includes an optical source 9 that generates an optical signal, such as an optical pulse, for interrogating the fiber optic tool 8, which is deployed in a borehole (not shown in FIG. 2), the tool comprising N shuttles 7 each containing arrays of active elements 2. In some embodiments, the optical source 9 may comprise a narrowband laser and a modulator that selects short pulses from the output of the laser. Optionally, an optical amplifier may be used to boost the peak power of the pulses. In some embodiments, this amplifier may be placed after the modulator. The amplifier may also be followed by a filter for filtering in the frequency domain (by means of a band-pass filter) and/or in the time domain (by means of a further modulator).

The pulses emitted from the optical source 9 may be launched into the sensing optical fiber tool 8 through a directional coupler 10, which separates

[symbol]

The backscattered optical signal returned from the sensing fiber optic tool 8 in response to the interrogating pulses may be detected and converted to an electrical signal at the detector 4. The detector 4 may include any suitable component configured to convert light signals received from directional coupler 10, to electrical signal suitable for processing. This electrical signal may be transferred to a signal processing module 5 which may include any suitable processing device (e.g., a microprocessor, microcontroller, digital signal processor, computer, etc.) configured to processing the data received from the sensors.

The system may include a controller 11; it may be any suitable processing equipment generally configured to generate signals to control the optical source 9 and process signal received from detector 4. This schema is typical for traditional fiber optic measurement systems.

In an exemplary embodiment, the seismic sensing fiber optic tool may be lowered into the borehole using known methods for conveying cables into wellbores, such as a control line containing an optical fiber cable, or a coil tubing containing an optical fiber cable, or a wireline cable with integrated optical fibers, among other methods. In some embodiments, the sensor arrays are permanently deployed for continuous production well monitoring. When the tool is positioned at desired location in the well bore, the vibration vehicle or other seismic source may be activated.

To monitor seismic signals optical pulses are launched into the fiber optic tool and reflected or scattered light generated in response to the pulses is detected [symbol] [symbol] geneity, as well as fluid content and pore pressure, rock mechanical properties, enhanced oil-recovery progress, CO₂ sequestration progress, elastic anisotropy parameters, induced fractures geometry and natural fracture orientation and intensity.

There has been described and illustrated herein various embodiments of a device in accordance with the present invention for downhole seismic data recording. While particular embodiments of the invention have been described, is in not intended that the invention be limited thereby. Therefore, it will be apparent to those skilled in the art that various changes and modifications may be made to the invention as described without departing from the spirit and scope of the appended claims.

1. A borehole seismic sensing fiber optic tool comprising:
a fiber optic cable to be lowered in a borehole, and at least one resonator array disposed on the fiber optic cable, each array comprising at least one active element having resonance self-frequency in a range of frequencies of seismic waves to be measured.

2. The borehole seismic sensing tool of claim 1 wherein active elements of each resonator array are discs.

3. The borehole seismic sensing tool of claim 1 wherein active elements of each resonator array are spheres.

4. The borehole seismic sensing tool of claim 1 wherein active elements of each resonator array are cylinders.

5. The borehole seismic sensing tool of claim 1 wherein active elements of each resonator array are made of piezoceramic.

6. The borehole seismic sensing tool of claim 1 wherein resonator arrays are disposed in shuttles, each shuttle comprising at least one resonator array.
